(19) United States
(12) Patent Application Publication
(10) Pub. No.: US 2011/0209283 A1
(43) Pub. Date: Sep. 1, 2011

(54) Medicated Steam Bath Cabin

(76) Inventor: Chun Guang Chen, Scarborouoh (CA)

(21) Appl. No.: 12/562,458

(22) Filed: Sep. 18, 2009

Related U.S. Application Data
(60) Provisional application No. 61/098,654, filed on Sep. 19, 2008.

(51) Int. Cl. A61H 33/06

(52) U.S. Cl. 4/524

(57) ABSTRACT

An improved steam cabinet includes a housing having an interior configured to receive the person with a seat contained in the interior. The housing has a door through which the person can enter and exit the interior, the door having a head aperture dimensioned to permit the person's head to project outside of the interior while the user is seated inside the interior. A steam generator is contained in the housing and coupled to the interior. The steam generator includes a vessel having a vessel housing and a vessel interior, the vessel interior being divided into an infusion chamber and a heating chamber by a baffle. A heating element is contained in the heating chamber. The vessel has an opening communicating with the infusion chamber through which a packet containing the herbal therapeutic agent may be inserted into the infusion chamber. The steam generator includes a closure for closing off the opening and water supply conduits for supplying water to the steam generator. The cabinet also includes a control unit for controlling the operation of the heating element.

### CROSS REFERENCE TO RELATED APPLICATION

The present application claims priority from U.S. provisional patent application No. 61/098,654 filed Sep. 19, 2008 and entitled “Medicated Steam Bath Cabin”, the entirety of which is incorporated herein by reference.

### FIELD OF THE INVENTION

The invention relates generally to steam cabins or lockers for administering a steam bath to a person sitting in the cabin.

### BACKGROUND OF THE INVENTION

Steam saunas are a well known way of relaxing and obtaining certain therapeutic benefits. Steam saunas generally consist of a heated room coupled to one or more steam generators. The steam generators ensure that the air in the sauna is both very humid and sufficiently hot to cause people sitting in the room to sweat profusely. Generally, the temperature inside the sauna is selected to ensure that the occupants in the sauna sweat profusely but do not suffer adverse effects from exposure to high temperatures (such as burning or heat stroke). Steam saunas are often operated at a range of between 30° C. to 50° C. with a relative humidity of 100%.

Steam bath cabinets provide a means by which an individual can reap the benefits of a steam sauna while not having to incur the expense and maintenance of a full steam sauna. These steam bath cabinets include a housing which is designed to hold an individual, preferably in a seated position, and a steam generator for filling the cabinet with steam. While steam bath cabinets are popular, their design permits only limited application. An improved steam bath design which provides the user with a more versatile therapeutic experience is therefore desirable.

### SUMMARY OF THE INVENTION

It is an object of the present invention to provide a steam cabinet having improved therapeutic use having the ability to deliver medicated steam to a person. The improved steam cabinet consists of a housing having an interior, a door, and a head aperture, the interior of the housing and the door aperture dimensioned to permit the person to sit inside the interior with the person's head projecting out of the head aperture. A steam generator for filling the interior with steam is contained in the housing. The steam generator generates steam by heating water in a vessel, the vessel having an infusion chamber for receiving a packet containing an herbal therapeutic agent. The steam cabinet also has a control unit for controlling the operation of the steam generator.

It is another object of the present invention to provide an improved steam cabinet which is easy to enter and exit and which provides a more therapeutic steam treatment by exposing the user to steam infused with herbal therapeutic agents. The improved steam cabinet includes a housing having an interior configured to receive the person with a seat contained in the interior. The housing has a door through which the person can enter and exit the interior, the door having a head aperture dimensioned to permit the person's head to project outside of the interior while the user is seated inside the interior. A steam generator is contained in the housing and coupled to the interior. The steam generator includes a vessel having a vessel housing and a vessel interior, the vessel interior being divided into an infusion chamber and a heating chamber by a baffle. A heating element is contained in the heating chamber. The vessel has an opening communicating with the infusion chamber through which a packet containing the herbal therapeutic agent may be inserted into the infusion chamber. The steam generator includes a closure for closing off the opening and water supply conduits for supplying water to the steam generator. The cabinet also includes a control unit for controlling the operation of the heating element.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a perspective view of a steam bath cabin made in accordance with the present invention.

FIG. 2. is a schematic sectional view of the steam bath cabin shown in FIG. 1 and showing the various working parts of the invention.

FIG. 3. is an exploded view of the steam bath cabin shown in FIG. 1 showing the steam bath cabin partly assembled.

FIG. 4 is a perspective view of the steam generator portion of the present invention showing the steam generator lid in a closed position.

FIG. 5 is an exploded view of the steam bath cabin shown in FIG. 1 showing the door portion of the steam bath cabin disassembled.

FIG. 6 is an exploded view of the door portion of the steam bath cabin shown in FIG. 1.

In the drawings like characters of reference indicate corresponding parts in the different figures.

### DETAILED DESCRIPTION OF THE INVENTION

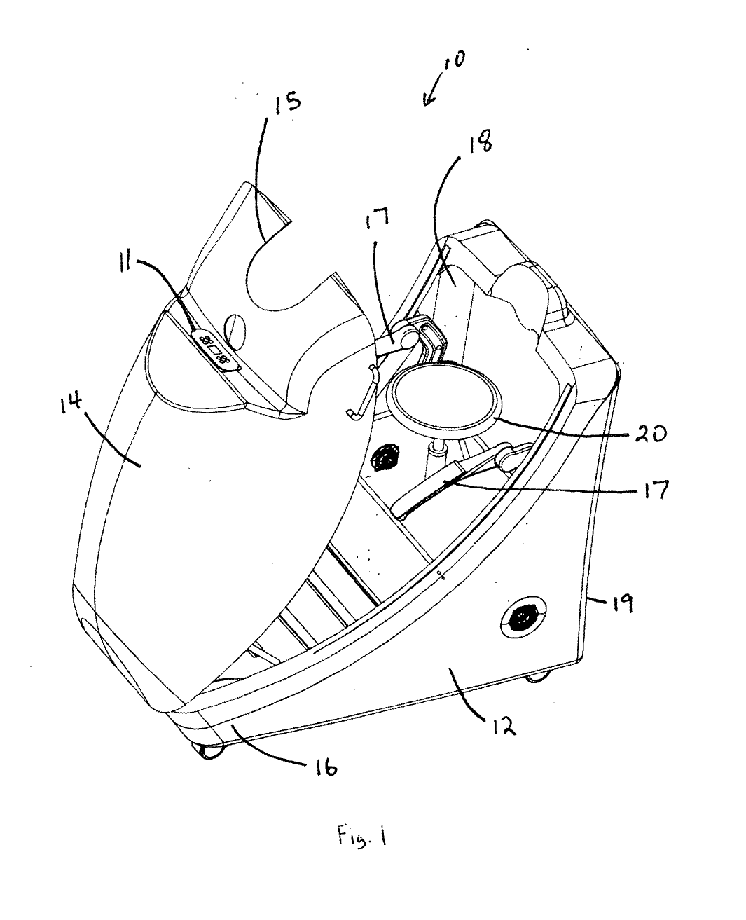

Referring firstly to FIG. 1, a steam bath cabin made in accordance with the present invention is shown generally as item 10 and comprises a clam shell type cabinet having base portion 12 and door portion 14 enclosing interior compartment 18 which is dimensioned to comfortably hold a person (not shown) within the cabinet while sitting on chair 20. Door 14 is pivotally coupled to base portion 12 at forward-bottom portion 16. Door 14 is provided with an aperture 15 to accommodate the user's head (not shown) so that the user's head protrudes out of the steam bath cabin when the door is closed onto the base portion. Cabin 10 also has arm rests 17 in interior 18. Base portion 12 has a bottom-rear portion 19 which houses a steam generator for filling interior 18 with steam. The operation of the steam generator is controlled by control unit 11.

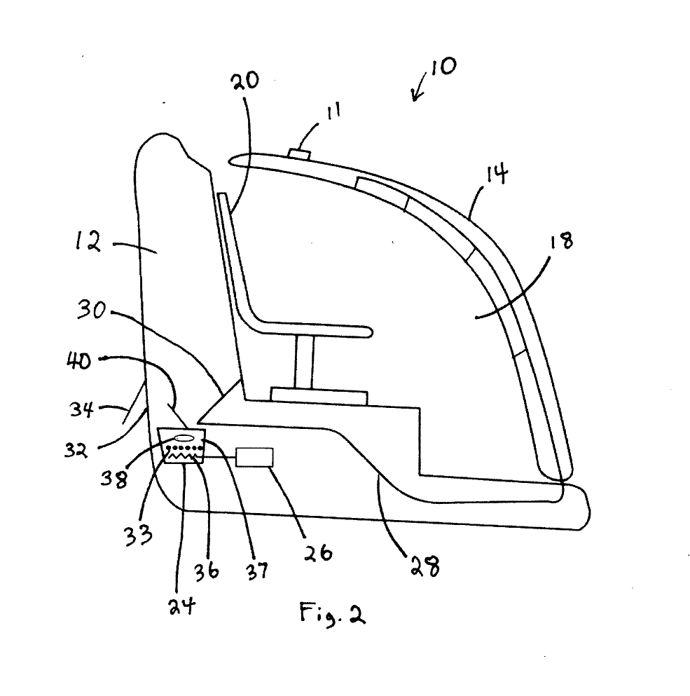

FIG. 2 is a schematic representation of the invention shown in FIG. 1 which illustrates the various components of the steam cabin. Contained within base 12 is steam generator 24 which is coupled to power unit 26 which is in turn coupled to control unit 11. Steam generator 24 has a heater 36 contained within a water filled vessel 37. Heater 36 is preferably an electric heating coil powered by power unit 26 which is selected to heat the water contained within the steam generator sufficiently to generate steam. Power unit 26 is a standard electric heating element controller for use in supplying electric power to an electric heating element. Control unit 11 may consist of any electric or electronic control unit capable of controlling power unit 26 so as to selectively turn on or turn off the power supplied to heater 36. Power units and control units suitable for use in the present invention are readily available on the market.

Steam from the steam generator passes through steam channels 30 and 28. Steam channel 28 passes into door 14 where it opens into chamber 18 via ports 42. Steam generator 24 has a baffle 33 which separates vessel 37 into a lower heating chamber containing heater 36 and an upper infusion chamber. Steam generator 24 is provided with a closure (lid) 40 which can be opened to insert herbal pouch 38 into the infusion chamber of vessel 37. Base 12 has access port 32 through which an operator may insert fresh herb pouches 38 and remove spent herb pouches as required. Access door 34 closes off access port 32.

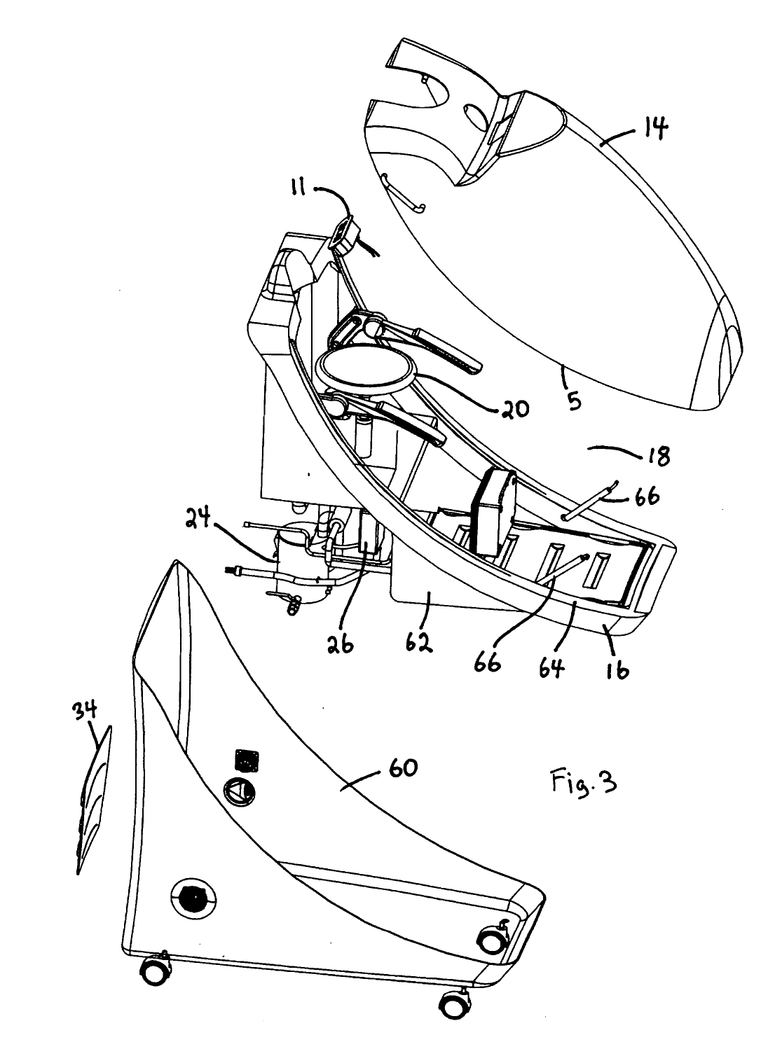

Referring now to FIG. 3, housing 12 consists of an outer shell portion 60 and an inner shell portion 62. Inner shell portion 62 has coupling members 66 for pivotally connecting door 14 to front-bottom portion 16 of the housing. Coupling members 66 align door 14 with inner shell portion 62 such that rim 68 of door 14 is aligned with circumferential edge 64 of the inner shell portion such that when door 14 is closed, rim 68 abuts against circumferential edge 64. Interior 18 is formed between shell portion 62 and door 14. The abutment of rim 68 and edge 64 is sufficiently close to ensure that steam contained within interior 18 does not leak out.

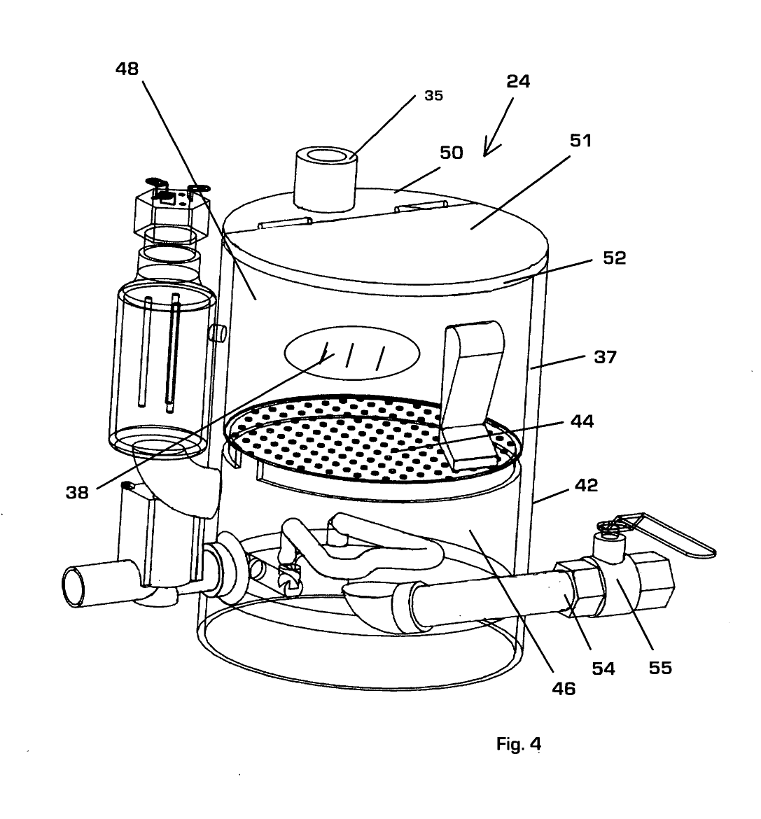

Referring now to FIG. 4, steam generator 24 has a water tight housing 42 which forms vessel 37. Baffle 44 divides the water chamber into upper infusion chamber 48 and lower heating chamber 46. Lower heating chamber 46 holds heater 36. Housing 42 is provided with a closure door 51 for containing the water within the housing and an opening 52 in the upper portion dimensioned to permit an operator to insert and remove herb pouches 38 from infusion chamber 48 as required. Preferably, heater 36 consists of a standard electrical heating coil which is controlled by control unit 11 (see FIGS. 1 and 3). The control unit is configured to operate heater 36 such that the heater causes the water contained within the steam generator to generate steam. Header 35 is positioned on top of top 50 to permit steam to exit the steam generator when door (closure) 51 closes off opening 52. Water intake line 54 is also provided to permit water to be injected into the steam generator. It will be appreciated that the steam generator may also include water level sensors (not shown) for automatically sensing the water level in the steam generator. Furthermore, water intake line 54 may be provided with a valve 55 for controlling the flow of water into the steam generator. Valve 55 may consist of a hand valve (as illustrated) or a solenoid type valve. The control unit may be coupled to these water level sensors and valves to automatically control the water level in the steam generator.

Separating the steam generator into a lower heating chamber and an upper infusion chamber by a baffle has several advantages. Firstly, the herbal pouches will be contained within the infusion chamber and kept away from the heater, preventing the scorching or burning of the herbal pouches which may result if the pouches directly contacted the heater. Also, the herbal pouches are easier to remove from the steam generator after they have been spent, since they may sink to the bottom after being exposed to heated water for several minutes. The baffle ensures that the submerged herbal pouches do not become entangled in the heating element. Furthermore, placing the heating chamber below the infusion chamber ensures that there is an efficient transfer of heated water to the infusion chamber since heated water rises. Also, since the steam evolves from the uppermost portion of the vessel, the steam being generated from the steam generator is more likely to be infused with herbal agents from the herbal pouch since the pouch is also located in the uppermost portion of the vessel.

Herbal pouch 38 consists of a quantity of one or more medicinal herbs, preferably of the type used in traditional Chinese medicine, contained within a water porous cloth or membrane. Cheese cloth can be used to wrap the desired herb (or combination of herbs) into a suitable pouch. Several different Chinese herbs have been used to treat or alleviate the symptoms of various conditions. Administering these herbs in an herb infused steam bath has various advantages. Firstly, steam infused with these herbs contains a different combination of ingredients than a tea, tincture or liquid infusion made from the same herb. Hence, an herb infused steam bath will deliver a different array of herbal ingredients as compared to sitting in bath water infused with the same herb, or drinking a tea made from the same herb. Also, the heat and humidity created in the steam cabin causes pores in the skin to open, permitting a greater and more thorough penetration of the herbal ingredients to the patient. The heat of the cabin also has a calming and relaxing effect on the patient. Finally, several of the disadvantages of using various herbs to treat conditions, such as the often unpleasant taste, can be avoided by using steam as opposed to a liquid infusion.

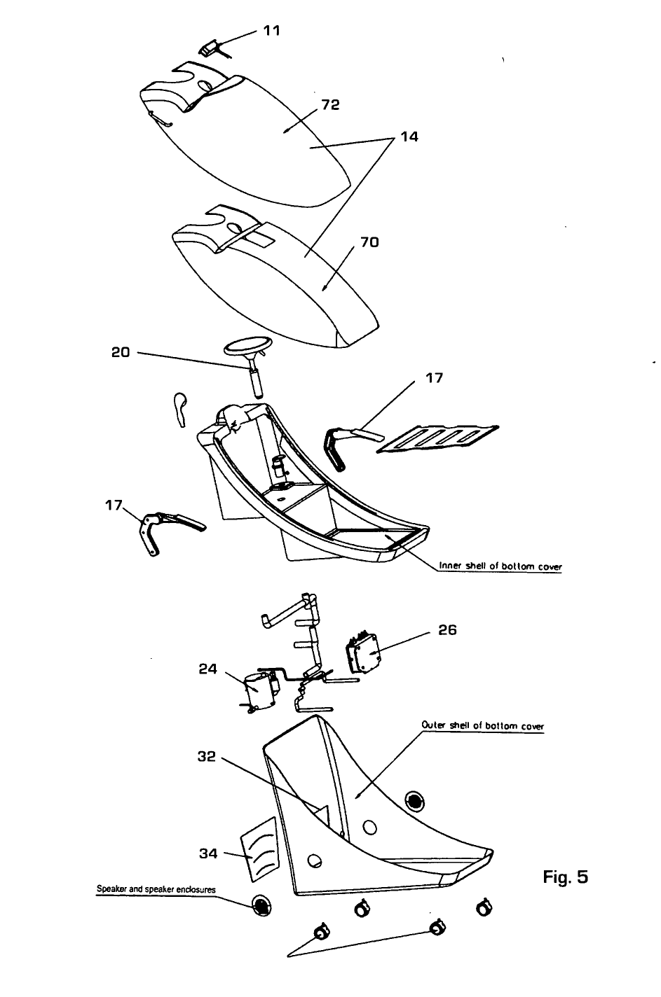

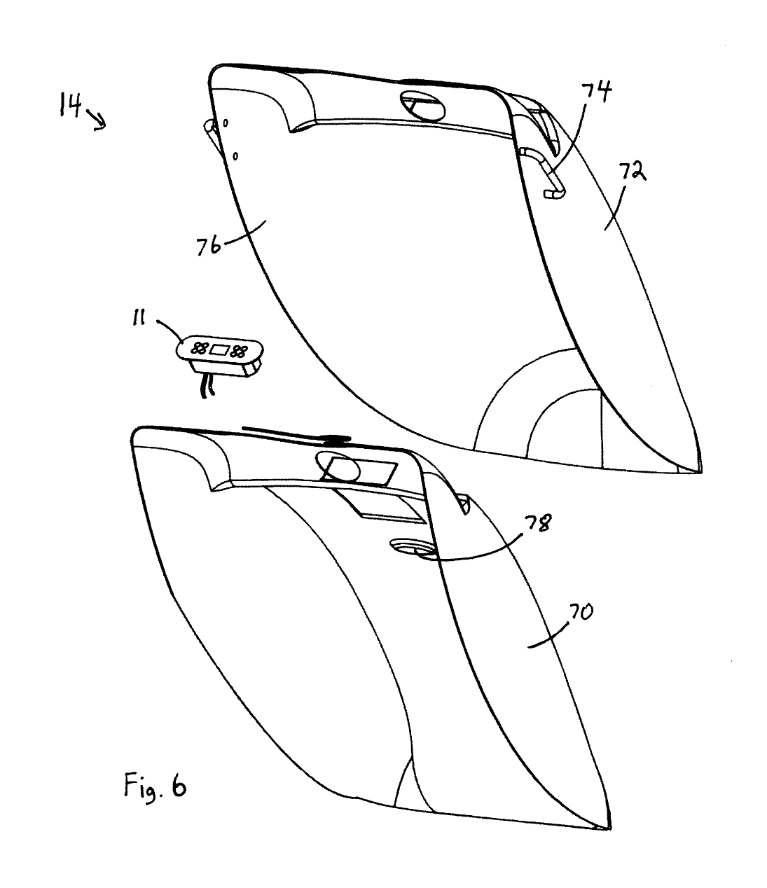

Referring now to FIGS. 5 and 6, door 14 preferably consists of an inner shell portion 70 and an outer shell portion 72. Shell portions 70 and 72 are preferably dimensioned and configured such that a space 76 exists between them when the two shell portions are brought together to form door 14. Space 76 may act as a steam channel carrying steam from the steam generator into the interior of the steam cabin.

Referring back to FIG. 2, to use the present invention to give an individual an herbal steam bath treatment, an operator first opens the access door at the back of the steam bath to gain access to the steam generator. The operator places a fresh herbal pouch into the infusion chamber of the steam generator. The operator then closes door 40 and door 34 and then turns on control unit 11 which is configured to cause heater 36 to heat the water contained within the steam generator. As the water in the steam generator heats up, various essential oils, esters, and other ingredients contained in herbal pouch 38 is infused into the water or expelled from the pouch. Many of these essential oils, esters and other ingredients then enter the steam and pass through steam lines 28 and 30 where they enter chamber 18. The person (not shown) sitting in chair 20 within chamber 18 is therefore treated with steam which has been infused and mixed with various constituent ingredients of the herbs contained in herbal pouch 38.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A steam bath cabinet for exposing a person to steam containing an herbal therapeutic agent, said cabinet comprising:
a) a housing having an interior configured to receive the person;
b) a seat contained in the interior;
c) said housing having a door through which the person can enter and exit the interior;
d) said door having a head aperture dimensioned to permit the person's head to project outside of the interior while the user is seated inside the interior;
e) a steam generator contained in the housing and coupled to the interior;
f) the steam generator comprising a vessel having a vessel housing and a vessel interior, said vessel interior being divided into an infusion chamber and a heating chamber by a baffle, a heating element being contained in the heating chamber;
g) the vessel having an opening communicating with the infusion chamber through which a packet containing the herbal therapeutic agent may be inserted into the infusion chamber;
i) a closure for closing off the opening;
j) water supply conduits for supplying water to the steam generator, and
k) a control unit for controlling the operation of the heating element.

2. A steam bath cabinet for exposing a person to steam comprising:
a housing having an interior, a door, and a head aperture, the interior of the housing and the door aperture dimensioned to permit the person to sit inside the interior with the person's head projecting out of the head aperture;
a steam generator contained in the housing for providing steam to the interior by heating water in a vessel, the vessel having an infusion chamber for receiving a packet containing an herbal therapeutic agent, and
a control unit for controlling the operation of the steam generator.

3. The steam bath cabinet of claim 2 wherein the door has a top and bottom portion, the bottom portion of the door being pivotally coupled to a bottom portion of the housing, the head aperture being at least partially formed on the top portion of the door.

4. The steam bath cabinet of claim 2 wherein the vessel of the steam generator has an opening leading into the infusion chamber and a vessel closure for closing off the opening, the opening dimensioned to receive the herbal packet.

5. The steam bath cabinet of claim 4 wherein the vessel closure comprises a door pivotally connected to the vessel.

6. The steam bath cabinet of claim 4 wherein the vessel is divided into the infusion chamber and a heating chamber, the heating chamber containing a heater for heating the water in the vessel.

7. The steam bath cabinet of claim 6 wherein the heating chamber is separated from the heating chamber by a baffle.

8. The steam bath cabinet of claim 7 wherein the vessel of the steam generator has an opening leading into the infusion chamber and a vessel door for closing off the opening, the opening dimensioned to receive the herbal packet.

9. The steam bath cabinet of claim 8 wherein the vessel door is pivotally connected to the vessel.

10. The steam bath cabinet of claim 7 wherein the infusion camber is positioned above the heating chamber.

11. The steam bath cabinet of claim 1 wherein the door has a top and bottom portion, the bottom portion of the door being pivotally connected to a bottom portion of the housing, the head aperture formed on the top portion of the door.

12. The steam bath cabinet of claim 11 wherein the housing has an access port positioned adjacent the steam generator, the access port dimensioned to permit access to the steam generator, an access port door being pivotally attached to the housing for closing off the access port.

13. The steam bath cabinet of claim 1 wherein the door has a steam passage coupled to the steam generator, the door having one or more steam ports for releasing steam from the steam passage into the interior.

14. The steam bath cabinet of claim 13 wherein the door has an inner and outer shell, the steam passage being formed between the inner and outer shell.

15. The steam bath cabinet of claim 2 wherein the door has a steam passage coupled to the steam generator, the door having one or more steam ports for releasing steam from the steam passage into the interior.

16. The steam bath cabinet of claim 15 wherein the door has an inner and outer shell, the steam passage being formed between the inner and outer shell.
